(19) United States
(12) Patent Application Publication
(10) Pub. No.: US 2006/0049038 A1
(43) Pub. Date: Mar. 9, 2006

(54) Dynamic profile anode

(75) Inventors: Thomas P. Griego, Corrales, NM (US); Fernando M. Sanchez, Albuquerque, NM (US)

Correspondence Address: PEACOCK MYERS, P.C., 201 THIRD STREET, N.W., SUITE 1340, ALBUQUERQUE, NM, 87102, US

(73) Assignee: Surfect Technologies, Inc., Albuquerque, NM (US)

(21) Appl. No.: 11/212,277

(22) Filed: Aug. 25, 2005

Related U.S. Application Data
(63) Continuation-in-part of application No. 10/778,647, filed on Feb. 12, 2004.
(63) Continuation-in-part of application No. 10/728,636, filed on Dec. 5, 2003.
(60) Provisional application No. 60/604,917, filed on Aug. 26, 2004.
(60) Provisional application No. 60/447,175, filed on Feb. 12, 2003.
(60) Provisional application No. 60/519,813, filed on Nov. 12, 2003.

(51) Int. Cl. B23H 3/02; C25C 7/02

(52) U.S. Cl. 204/228.1; 204/280

(57) ABSTRACT

A dynamic profile anode whose shape can be varied to optimize the current distribution to a substrate during highly controlled electrodeposition. Enhanced control of the process provides for a more uniform deposit thickness over the entire substrate, and permits reliable plating of submicron features. The anode is particularly useful for electroplating submicron structures. The anode is advantageously able to use metallic ion sources and may be placed close to the cathode thus minimizing contamination of the substrate. The anode profile may be varied during the deposition process. The anode may consist of multiple concentric regions, each of which may be operated at independent voltages and currents.

### CROSS-REFERENCE TO RELATED APPLICATIONS

This application claims the benefit of the filing of U.S. Provisional Patent Application Ser. No. 60/604,917, entitled “Dynamic Profile Anode”, filed on Aug. 26, 2004. This application is also a continuation-in-part application of U.S. patent application Ser. No. 10/778,647, entitled “Apparatus And Method For Highly Controlled Electrodeposition”, filed on Feb. 12, 2004, which claimed the benefit of the filing of U.S. Provisional Patent Application Ser. No. 60/431,315, entitled “Solid Core Solder Particles for Printable Solder Paste”, filed on Dec. 5, 2002, U.S. Provisional Patent Application Ser. No. 60/447,175, entitled “Electrochemical Devices and Processes”, filed on Feb. 12, 2003, and U.S. Provisional Patent Application Ser. No. 60/519,813, entitled “Particle Coelectrodeposition”, filed on Nov. 12, 2003, and which is also a continuation-in-part of U.S. patent application Ser. No. 10/728,636, entitled “Coated and Magnetic Particles and Applications Thereof”, filed Dec. 5, 2003. The specifications and claims of each application listed are incorporated herein by reference.

### BACKGROUND OF THE INVENTION

1. Field of the Invention (Technical Field)

The present invention relates to an apparatus and method for electroplating substrates or other objects, particularly semiconductor wafers. The present invention can also be used to plate ceramic panels used in thin or thick film type packaging, as well as anti-reflective coatings of lenses and other types of glass substrates. The apparatus may also be used for microvia deposition, wafer bumping, and flip chip bumping. The apparatus provides for a much higher control of the deposition parameters, enabling fine submicron features to be plated. The invention also relates to an anode for electrochemical processes whose profile can be varied to any desired shape. The anode may be used with metallic ion sources without contaminating the substrate.

2. Background Art

Note that the following discussion is given for more complete background of the scientific principles and is not to be construed as an admission that such concepts are prior art for patentability determination purposes.

A traditional electroplating cell comprises a tank to hold the chemical solution, one or two anodes that are either of a soluble composition of the metal to be deposited or insoluble platinized anodes. The item to be plated is mounted horizontally on the cathode, at a gap of approximately four inches from the anode(s). A DC power supply, operating with either a constant, switched or pulsed output, with an optional periodic polarity reverse is most often utilized in current cells. Configurations of this type do not provide sufficient control over the deposition process to enable the uniform plating of submicron features on a substrate. Nor can the operating geometries and other parameters of the cell be easily varied to accommodate different types of plating substrates or patterns, or to adjust the plating conditions to ensure uniformity and quality of the deposit.

It is known in the art to enhance the deposit uniformity by introducing an aperture to selectively mask off the edges of the substrate. However, when plating submicron structures it is critical that the size of the aperture be adjustable to more precisely control the thickness uniformity, whether before or during processing. In addition, an adjustable aperture enables the cell to be used for multiple types of deposits, reducing the capital equipment requirements of the user, and minimizing contamination by avoiding transfer of the substrate from one cell to another.

The use of shaped anodes to improve deposit uniformity and efficiency are also known in the art. However, the optimal shape depends on the particular electrochemical process and the characteristics of the pattern on the substrate, among other things. Thus there is a need for an anode with variable shape capabilities.

Another drawback of the existing art is that in order to place the anode close to the cathode, an insoluble anode must be used with a metal salt solution, which is inferior to a metallic ion source. Alternatively, a soluble metallic anode may be used, but it cannot be placed close to the cathode because of potential contamination. In addition, as the anode dissolves it changes shape, reducing the very control of the deposit parameters that was provided by choosing the initial shape of the anode. Accordingly, there is a need for an insoluble anode that can use metallic ion sources and that be placed close to the cathode.

### SUMMARY OF THE INVENTION (DISCLOSURE OF THE INVENTION)

The present invention is of an apparatus for electrochemical deposition on a substrate such as a wafer, the apparatus comprising an anode, a cathode with a vertical mounting surface, a pressurized cell to contain electrolytic solution, and an aperture disposed between the anode and cathode; wherein a vertical flow of the electrolytic solution is substantially laminar in a vicinity of the cathode. The apparatus optionally comprises a reservoir, which preferably forms a closed, filtered system with the cell. At least one filter is preferably a submicron filter.

The wafer may optionally be coated so that only certain features, such as submicron features, on the wafer receive the deposition.

The cell is preferably pressurized to at least approximately one atmosphere above ambient pressure, and optionally is pressurized to at least approximately two atmospheres above ambient pressure. The cathode preferably rotates about a horizontal axis perpendicular to said mounting surface. The cell preferably has a geometry that facilitates said laminar flow, for example comprising an inverted triangular or conical shape in a vicinity of an electrolyte inlet port. Additionally the cell is preferably of sufficient height to ensure that said flow is laminar in a vicinity of said cathode.

The aperture is preferably electrically insulating, and preferably comprises a circular opening which is variable in size, optionally during operation of the cell. The aperture preferably comprises an iris with at least three paddles. The opening is preferably continuously variable from a size larger than the size of the substrate to completely closed.

The anode is preferably situated less than approximately 5 cm, more preferably less than approximately 1 cm, and most preferably less than approximately 0.5 cm from the cathode. The metal ion source is preferably situated behind the anode, thereby minimizing contamination from reaching the substrate while the anode retains a constant surface profile. The surface profile of said anode is preferably controllably variable, and may be varied during operation of the cell. The anode preferably comprises parallel hollow electrically conducting tubes.

The apparatus may optionally comprise a magnet, such as an electromagnet or at least one permanent magnet. The magnet preferably provides for the codeposition of magnetic particles along with the electrochemical deposition on the substrate. The codeposition may occur before, during, and/or after the electrochemical deposition. The strength of the magnet is preferably adjusted to provide a desired concentration of magnetic particles on the substrate.

The invention is further of an apparatus for performing multiple electrochemical depositions on a substrate, the apparatus comprising an anode having a variable surface profile, a cathode with a vertical mounting surface, a pressurized cell to contain electrolytic solution, a closed, optionally filtered system for circulation of the solution, and an aperture with a variably sized opening disposed between the anode and the cathode; wherein a vertical flow of the electrolytic solution is substantially laminar in the vicinity of the cathode. The multiple depositions are preferably carried out without opening the cell between each deposition, even though the surface profile of the anode and/or the size of the opening are preferably controllably varied as desired for each deposition.

The invention is also of a method of electrolytically depositing a material on a substrate, the method comprising the steps of providing an electrolytic cell, providing an anode, mounting the substrate on a cathode so that a surface of the substrate is vertically disposed, disposing an aperture between the anode and cathode, providing laminar flow of electrolyte solution through a cell, pressurizing the solution to a desired pressure, and providing an electric potential difference between the cathode and the anode. The solution is preferably filtered. Optionally, submicron features on the substrate are uniformly plated. The substrate is preferably rotated about a horizontal axis perpendicular to the surface, and the aperture preferably has a variable size opening.

The method preferably comprises situating the anode less than approximately 5 cm, more preferably less than approximately 1 cm, and most preferably less than approximately 0.5 cm from the cathode. The anode is preferably situated between a metallic ion source and the cathode and preferably minimizes contamination from reaching the cathode while retaining a constant surface profile. The surface profile of the anode is preferably controllably varied as desired. Optionally a magnetic field is provided to codeposit magnetic particles with the material on the substrate. The magnetic field is preferably varied to adjust the composition of the magnetic particles on the substrate.

The invention is further of a method of performing multiple electrolytic depositions on a substrate, the method comprising the steps of providing a pressurized electrolytic cell, providing an aperture with a variably sized opening, optimizing deposition parameters of the cell including a pressure of the cell and a size of the opening for a desired deposition, depositing a material on a substrate; and repeating the above steps without opening the cell.

The invention is also of an anode for use in an electrochemical process, the anode comprising a plurality of parallel hollow electrically conducting tubes with sides in slideable contact with one another and a clamp circumferentially disposed around the plurality of tubes to prevent motion of the tubes. The tubes are preferably cylindrical or have a cross section comprising a regular polygon. The surface profile of the anode preferably comprises the positions of the ends of each of the tubes which face the cathode. The anode's surface profile is preferably adjustable by sliding the tubes relative to one another, and preferably comprises a flat, convex, hemispherical, conical, domed, curved, or pyramidal shape.

The anode preferably comprises an electrically conducting material, which may be soluble, or preferably insoluble, for example platinized. The anode preferably comprises a receptacle for placement of an electrochemical ionic source media, preferably a metallic ion source, on the side of the anode opposite the surface profile. The anode minimizes contamination from reaching the cathode while retaining a constant surface profile. The anode is preferably used in any of the following processes: plating, electroplating, electrodeposition, chemical and mechanical polishing (CMP), electropolishing, etching, or electrolysis.

The present invention is also an anode for use in an electrochemical process, the anode comprising a plurality of parallel electrically conducting elements arranged in a plurality of zones and one or more separators for separating the zones. The zones are preferably concentric. Each zone preferably comprises a shape selected from the group consisting of circle, polygon, and regular polygon. A surface profile of the anode is preferably variable during operation of the electrochemical process. The separators are preferably electrically insulating. An electrical characteristic of each of the zones is preferably independently settable and is preferably selected from the group consisting of voltage and current. The anode preferably further comprises a multi-channel rectifier. The zones optionally comprise the same voltage and current setting.

The present invention is also a method of electrolytically depositing a material on a substrate, the method comprising the steps of providing an electrolytic cell, providing an anode comprising a plurality of parallel electrically conducting elements arranged in a plurality of separated zones, and independently setting a value of an electrical characteristic for each of the zones. The electrical characteristic is preferably selected from the group consisting of voltage and current. The setting step is preferably performed while the material is being deposited on the substrate. The setting step is optionally performed before the material is deposited on the substrate. The separated zones are preferably concentric. The method preferably further comprises the step of monitoring a deposit characteristic selected from the group consisting of flatness, homogeneity, and microstructure, in which case the setting step is preferably performed in order to improve the characteristic. The method preferably further comprises the step of varying a surface profile of the anode, wherein the varying step is performed while the material is being deposited on the substrate. The method optionally further comprises the step of measuring a value of a parameter selected from the group consisting of deposit thickness, deposit uniformity, electrolyte concentration, operating current, and operating voltage, in which case the varying step is preferably performed in response to the measured parameter value.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is an exploded view of a preferred embodiment of the electrodeposition apparatus of the invention;

FIG. 2 is an isometric view of the cell and reservoir;

FIG. 3 shows a cross section of the cell;

FIG. 4 depicts a close up of the cross section of the plating area of the cell;

FIG. 5 shows the chuck in position for wafer loading or unloading;

FIG. 6 shows the wafer in the loaded position;

FIG. 7 shows the chuck rotated to the vertical position;

FIG. 8 shows a cross section of the wafer chuck;

FIG. 9 is a detail of the rotating wafer mount;

FIG. 10 is an isometric view of the rear of the chuck, showing the rotation mechanism;

FIG. 11 is a cutaway view of the cell depicting the iris fully open;

FIG. 12 is a cutaway view of the cell depicting the iris partially masking the substrate;

FIG. 13 is a cutaway view of the cell depicting the iris fully closed;

FIG. 14 shows an isometric view of one embodiment the dynamic profile anode assembly;

FIG. 15 shows an exploded view of the dynamic profile anode assembly;

FIG. 16 shows a top view and cross section of the dynamic profile anode assembly depicting a convex surface profile;

FIG. 17 depicts the dynamic profile anode and clamp showing a convex surface profile;

FIG. 18 is an exploded view of FIG. 17;

FIG. 19 is a cross sectional view of a second embodiment of the dynamic profile anode with a flat surface profile;

FIG. 20 is a cross sectional view of the dynamic profile anode with a convex surface profile;

FIG. 21 is a cross sectional view of the dynamic profile anode with a conical surface profile;

FIG. 22 is an isometric view of the dynamic profile anode and anode diaphragm showing the conical surface profile;

FIG. 23 shows a cross section of the wafer chuck comprising an electromagnet;

FIG. 24 shows a schematic of the cell of the present invention configured to provide co-deposition of magnetic particles;

FIG. 25 is a detail of a preferred embodiment of the concentric zone anode assembly of the present invention;

FIG. 26 is a perspective view of the face a preferred embodiment of the concentric zone anode assembly of the present invention;

FIG. 27 is a view of the face of a preferred embodiment of the concentric zone anode assembly of the present invention;

FIG. 28 is a view of the back of a preferred embodiment of the concentric zone anode assembly of the present invention; and

FIG. 29 is a perspective view of the rear contact area of a preferred embodiment of the concentric zone anode assembly of the present invention.

### DESCRIPTION OF THE PREFERRED EMBODIMENTS (BEST MODES FOR CARRYING OUT THE INVENTION)

The present invention is of an apparatus and method for highly controlled electrodeposition, particularly useful for electroplating submicron structures. Enhanced control of the process provides for a more uniform deposit thickness over the entire substrate, and permits reliable plating of submicron features, for example those on a semiconductor wafer. A primary advantage of the invention is that the kinetics of the cell, which are based on the geometries of the cell, can be changed quickly to optimize plating on the substrate surface, for all deposits including very thick film deposits and thin film deposits.

As used throughout the specification and claims, “substrate” means any substrate, wafer, lens, panel, and the like, or any other item which is to be attached to an electrode to be plated. Such substrate may comprise any material such as a semiconductor, including but not limited to silicon, gallium arsenide, sapphire, glass, ceramic, metal alloy, polymer, or photoresist.

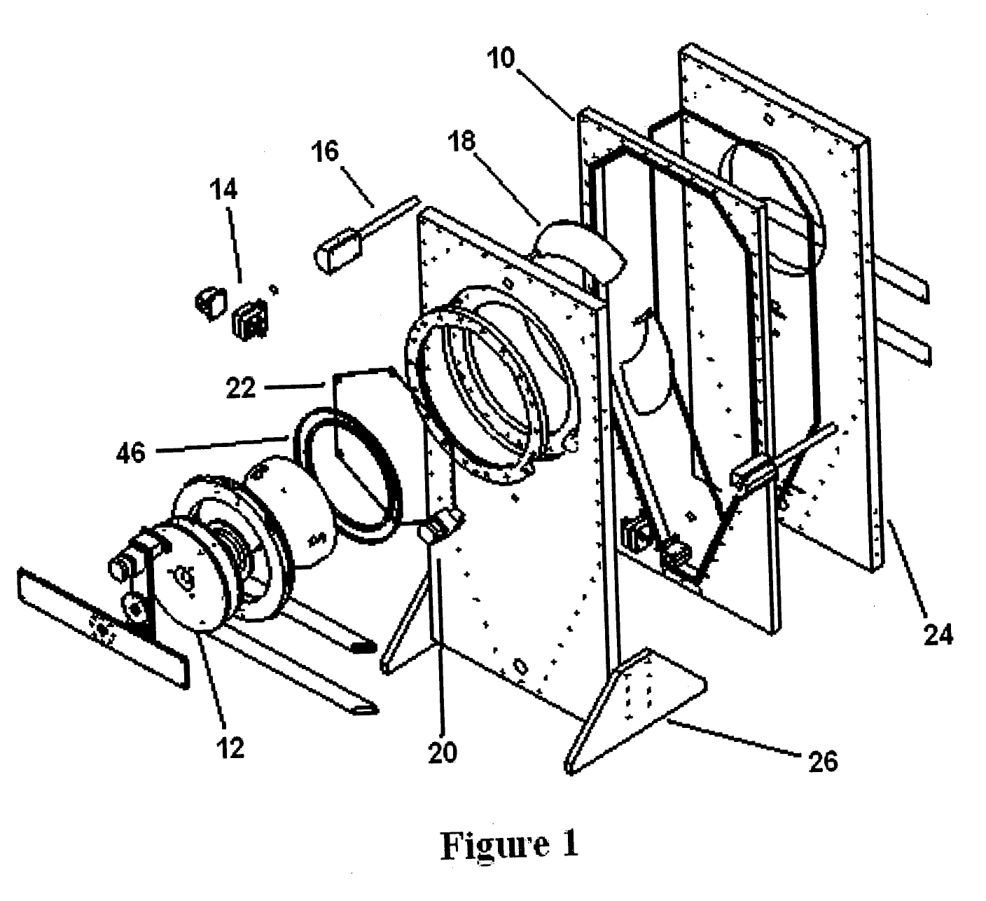

FIG. 1 depicts an exploded view of a preferred embodiment of electrodeposit cell 10 of the present invention comprising bulkhead 24 and bulkhead door 26. Substrate chuck 12 is rotatable using pivot assembly 14 and slides on guide rod 16 to seal against the opening in bulkhead door 26. Aperture 18 is located between bulkhead 24 and bulkhead door 26, and is operated using stepper motor 20 which drives belt 22.

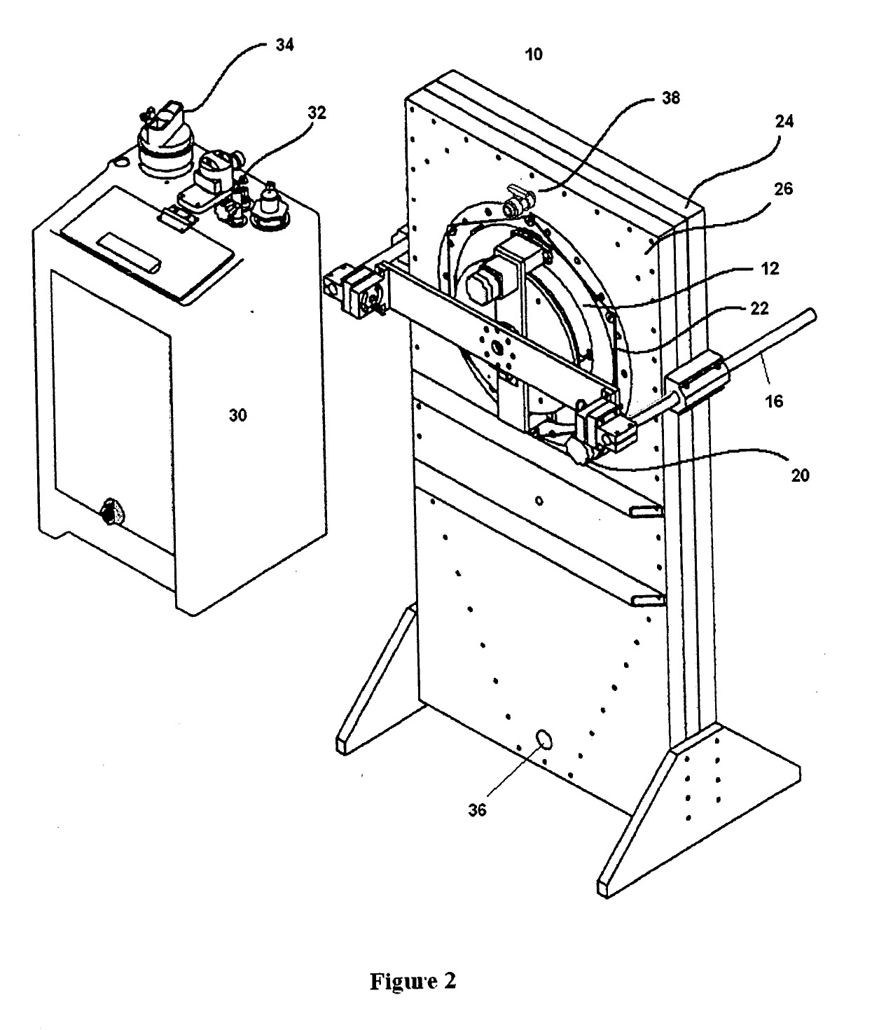

Referring to FIG. 2, reservoir 30 is where filter 34 and pump 32 are preferably mounted, as well as instrumentation for controlling the characteristics of the electroplating solution or electrolyte that is introduced into the WAVE Cell, such as temperature, pH, and concentrations of metal species and other electrolyte components. This ensures that all electrolyte characteristics are maintained at an optimal level. Any type of brightener system may also be checked. All chemical maintenance is preferably carried out in reservoir 30. Optionally, rather than being a standalone unit, the reservoir may be integral with the cell itself. The electrolyte solution is pumped into cell 10 through solution inlet 36. Pressure valve 38 regulates the pressure in the cell, as more fully described below, and controls the circulation of the electrolyte solution back to reservoir 30.

Unlike traditional electroplating devices, the entire circulation path of the solution, and the process environment in which the wafer is placed, is preferably enclosed, and more preferably comprises at least one filter, including but not limited to a submicron filter. Thus the electroplating environment is equivalent to a clean room, without requiring the latter's expense, and ensures a reliable and uncontaminated deposit process.

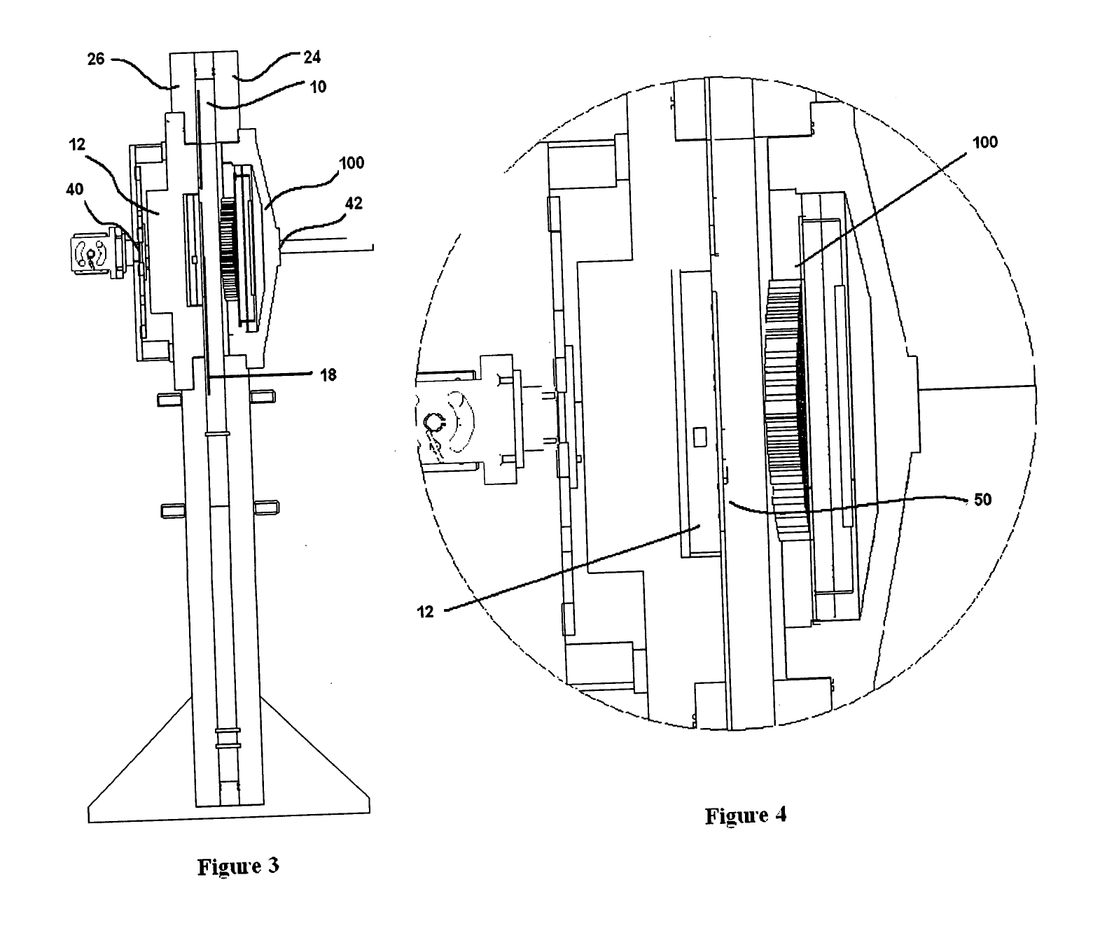

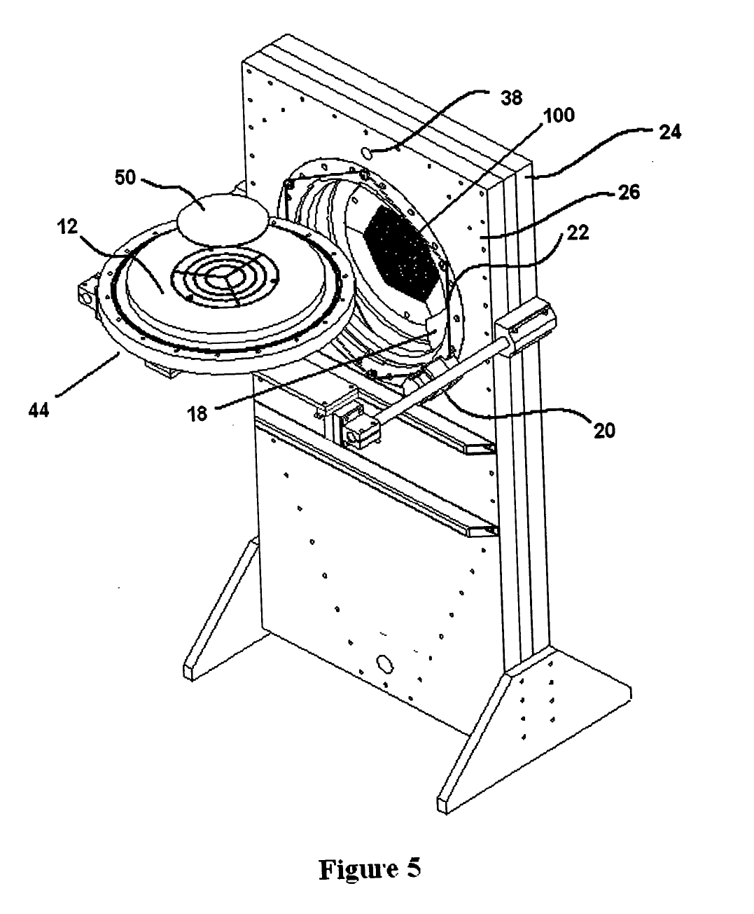

As shown in FIG. 3, connected to the cell's cathode will preferably be the negative terminal 40 of a DC power supply, operating with either a constant, switched or pulsed output, or with optional periodic polarity reversal, and connected to anode 100 will preferably be the positive terminal 42 of the power supply. FIG. 4 is an enlarged detail.

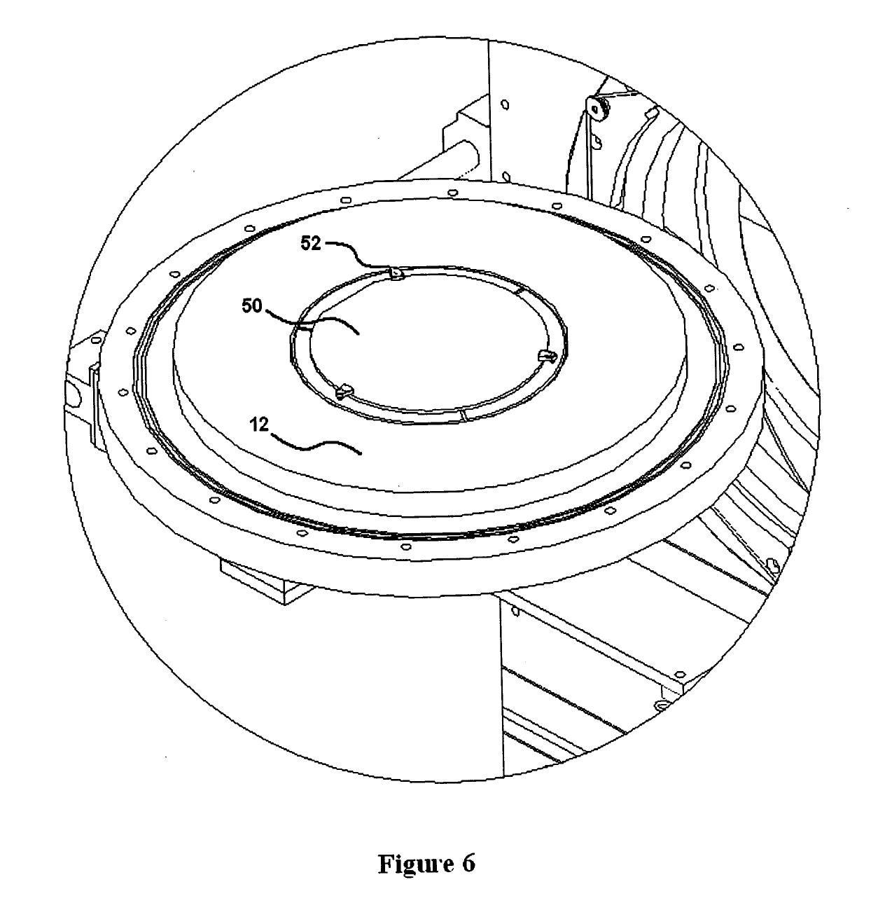

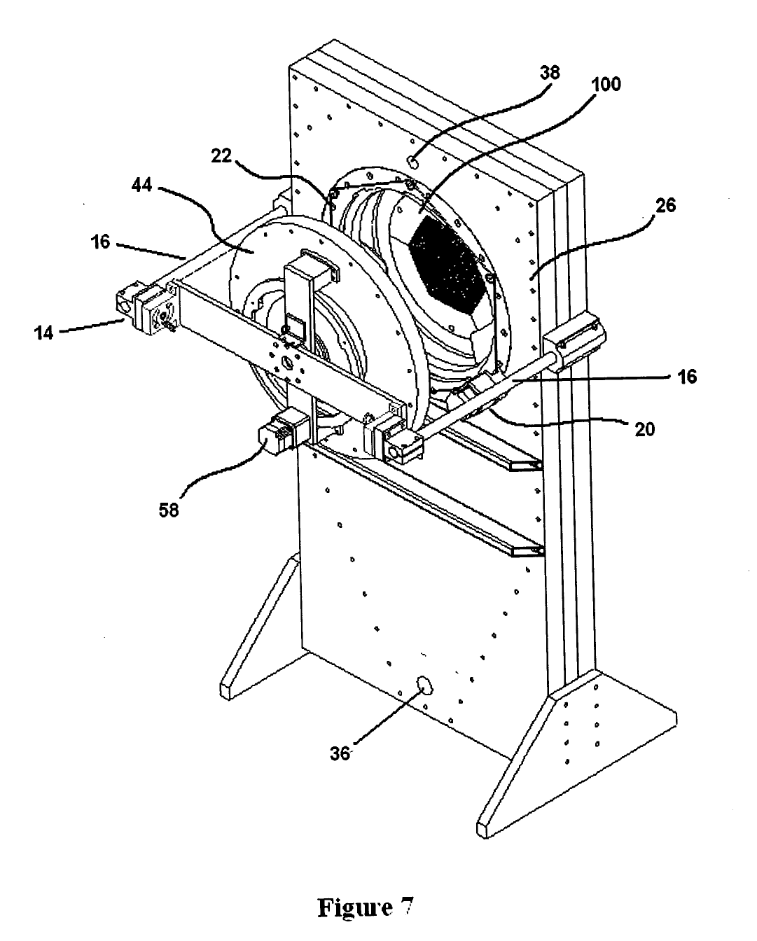

Chuck 12 is preferably comprised of articulating door 44 that can be opened and can interface with automation known in the art for mounting and dismounting of the substrate, permitting automated substrate loading and unloading. As shown in FIGS. 5 and 6, substrate 50 is mounted on chuck 12, which is preferably in the horizontal position. Chuck 12 holds substrate 50 on a flat surface and supplies the cathodic current to the surface of substrate 50 via at least one contact 52. Thus chuck 12, and more specifically substrate 50, acts as the cathode in the present system, and the terms are used interchangeably herein. Cell 10 of the present invention is capable of handling substrates in a large size range, such as wafers used in the semiconductor industry, including but not limited to those from 75 mm to 300 mm in diameter. Optionally, the edges of the substrate may be masked by a grip ring, preferably comprised of both metallic and insulating materials, that will supply current at the edge of the substrate while masking the edge of the current contact itself so that unnecessary deposits don't occur on the contact. FIG. 7 shows door 44 rotated into the vertical position about pivot assembly 14 so it is ready to slide along guide rods 16 and seal the opening in bulkhead door 26.

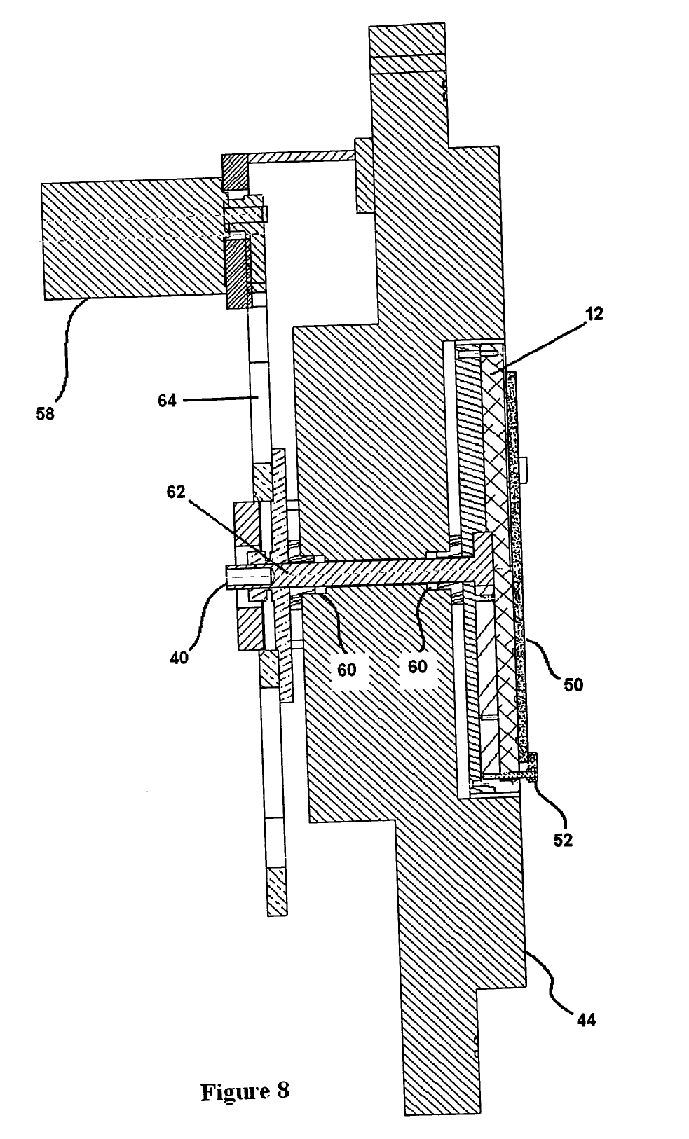

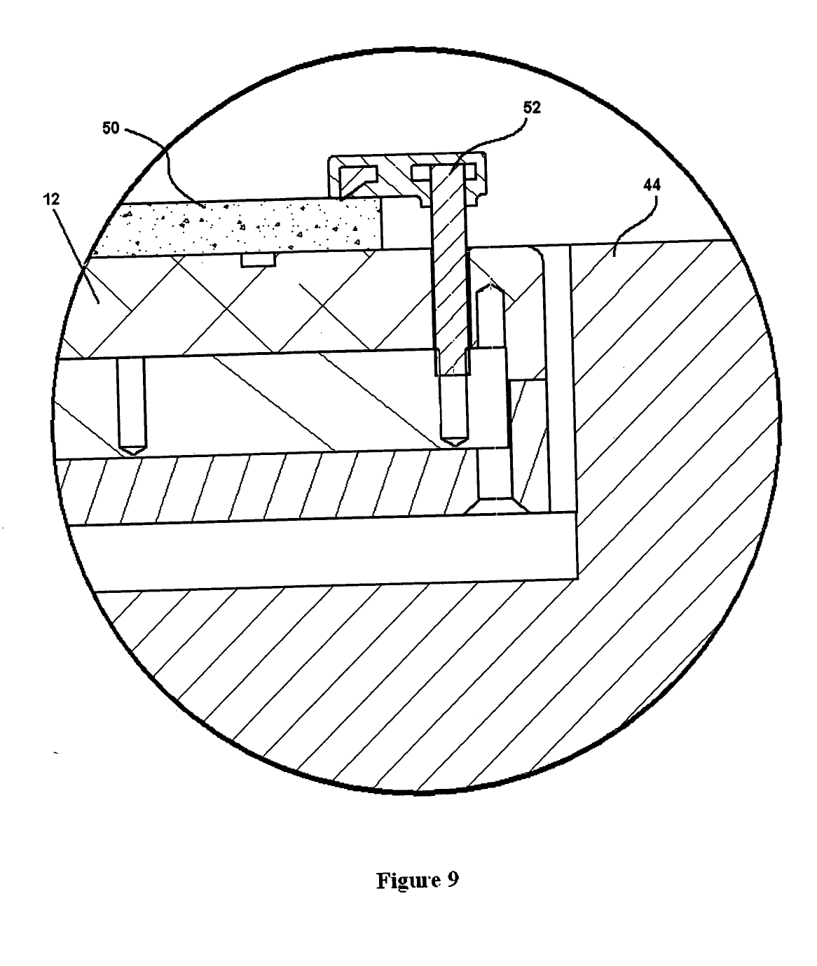

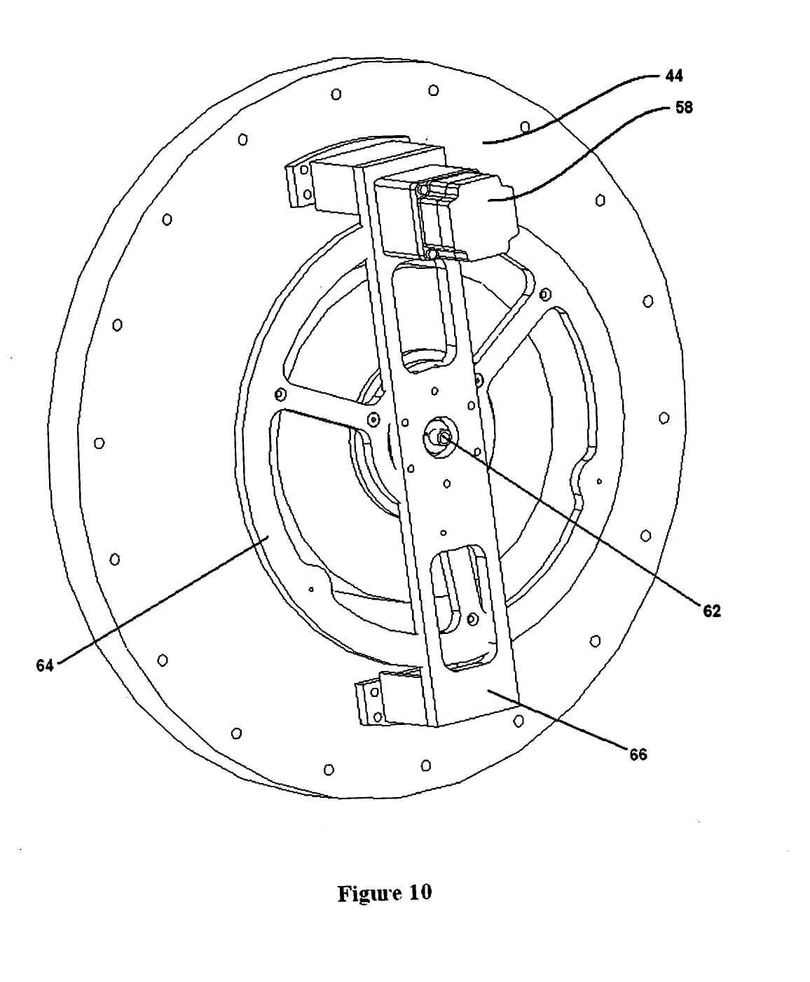

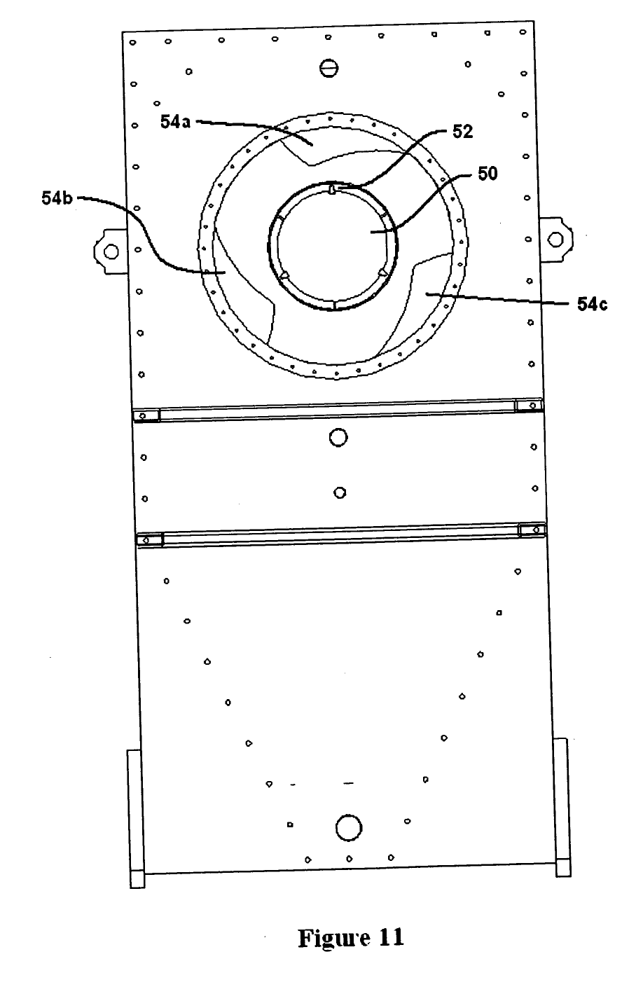

Chuck 12 is preferably rotatable, which provides advantages in uniformity of deposit that are described more fully below. Various views of the rotation mechanism are presented in FIGS. 8-10. Motor 58, optionally mounted on motor mount 66, is preferably used to provide such rotation, connecting via gear 64 or other rotation transfer means, such as a belt, to rotating shaft 62 that protrudes through o-ring seals 60 in articulating door 44. A DC current is preferably fed through shaft 62 via negative terminal 40, which will continuously supply cathodic current during the process run. Once door 44 is closed, it can optionally be fastened with bolts around the perimeter of the door and sealed by compressive-type gasketing 46.

The electrolyte, or plating, solution is then circulated into the cell, preferably entering from the base of the cell via solution inlet 36. A process controller will preferably continue the circulation of the electrolyte through the system until the desired thickness has been deposited. Typical process steps for operating the present cell preferably comprise a first rinsing, pretreatment with an activating acid or cleaner, a second rinsing, electroplating, and a final rinsing. Optionally, post-treatment operations for sealing or for mask or photoresist removal may be performed.

The pressure of the solution in cell 10 is regulated by pressure valve 38 or other type of pressure regulator, which preferably pressurizes the cell to one or two atmospheres above open cell, or ambient, pressure. However, any pressure may be utilized. For example, valve introduces back pressure into the cell, which optionally is monitored and controlled by a pressure gauge or other controller. The ability to pressurize the cell provides control over pressure dependent characteristics of the plating process, for example deposit kinetics, which results in improved performance and an improved deposit.

Controlling the pressure in the cell also improves solution exchange and ion supply on all surfaces of the wafer, including deep filled vias and planer surface areas. In addition, pressurization of the cell provides a high efficiency of deposition at lower current densities. Existing electroplating systems are not able to electroplate submicron structures in part because the mass transfer of ions from the anode to the cathode has been incompatible in terms of the scale of the pattern that is built up on the surface of the wafers. According to the present invention, using lower amperage densities, optionally combined with switching the current on and off, enables finer control of the deposit parameters. Thus submicron structures can be successfully electroplated and nanoscale vias can be filled uniformly, making electrolytic processes such as electroplating a viable alternative to an angstrom scale process like sputtering or vapor deposition.

Pressurizing the cell will also suppress the formation of gases such as hydrogen at the deposition interface, (i.e. the cathode, or substrate, surface). These gases cause undesirable porosity or voids resulting in micropittings that typically occur in a deposit on the surface of the cathode. Gases such as hydrogen also may reduce the mechanical strength of the deposit; if hydrogen is left in the boundary area, brittle deposits or highly stressed deposits may be formed, resulting in tensile failure and possibly the deposit peeling back from the substrate. The integrity of the bond of the deposit, such as a metallic interconnect, to the substrate or wafer is critical to assure the high reliability necessary for electronic components.

For applications in the submicron range, particulates, pores, and micropittings that would normally be acceptable in traditional plating applications are not tolerable because of the small size of the features to be plated as well as the required thinness of the deposit. Thus the overall control of micropittings is of paramount importance if semiconductor wafers are to be electroplated. By using pressurization to minimize gas formation, the integrity of the initial deposit on the surface of the wafer (when the voltage or the potential is at its highest), which creates the first boundary layer between the substrate and the metal being deposited, will be greatly improved. This results in a surface morphology of sufficient quality to successfully plate submicron structures.

The vertical configuration of the preferred embodiment of cell 10 also helps to reduce the presence of undesirable gas and gas bubbles at the surface of substrate 50 due to the laminar flow of electrolyte past the surface, which acts together with gravity to remove the gas upward away from the interface area of the substrate. The electrolyte optionally passes through baffles which distribute the pressure within the solution and help create laminar flow. Laminar flow formation is also preferably promoted by utilizing a non-rectangular shape of cell 10 adjacent to solution inlet 36, preferably a triangular or conical shape, as shown in FIG. 1. The length of cell 10 is long enough to transform the turbulent flow of the plating solution when introduced in the base of the cell to a laminar flow as it passes the surface of the wafer. The pressurization of the cell contributes to shortening the overall length of the cell required to achieve the laminar flow.

Laminar flow also enhances the plating solution by continuously and uniformly supplying solution of the optimum temperature and pH and ion species to the substrate. By sweeping out gases and supplying a continuous, reliable supply of electrolyte to the substrate, a more robust and uniform deposit is achieved, allowing for a greater range of chemical compositions for high-throw or low-throw baths to be utilized, giving the chemical process engineer more latitude. If laminar flow is not present, a defect or non-uniformity of the deposit's thickness or mechanical properties may result.

The present invention also comprises further multiple means to greatly enhance the uniformity of the thickness of the deposit on substrate 50. The thickness can be kinetically controlled across the entire substrate by rotation of substrate 50 as described above, and by selective masking of the substrate's exposure to anode 100, which techniques serve to provide a far more uniform current density at all points on substrate 50.

In the present invention substrate 50 is preferably mounted on rotating chuck 12 comprising the cathode. Thus the leading edge of substrate 50 with respect to the directional flow of the plating solution, which ordinarily will develop a thicker deposit than the rest of the substrate, is continually changed, distributing the mechanical forces on the substrate's edge as well as leveling out the thickness of the plating at the edge, making it more consistent with that at the center of the substrate.

Another cause of thickness nonuniformity in a traditional electroplating cell, the “dog bone” effect, occurs because current densities are higher at the edges of the cathode or substrate, meaning that the deposit will have a greater thickness there. By using an electrically insulating aperture, or masking device, the center of the substrate, where current densities are the lowest, receives preferentially higher exposure to the current, and the edges of the substrate, where the amperage densities are highest, is masked off from the current. The thickness of the deposit is thus more uniform across the entire substrate. Although masking is known in the art, only fixed apertures have been utilized.

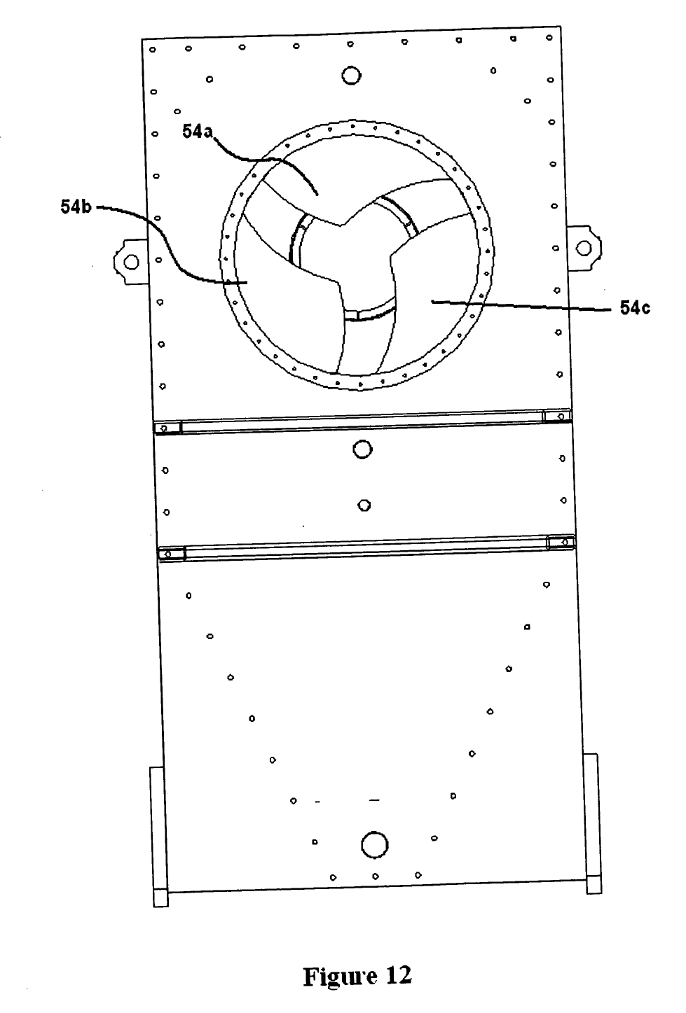

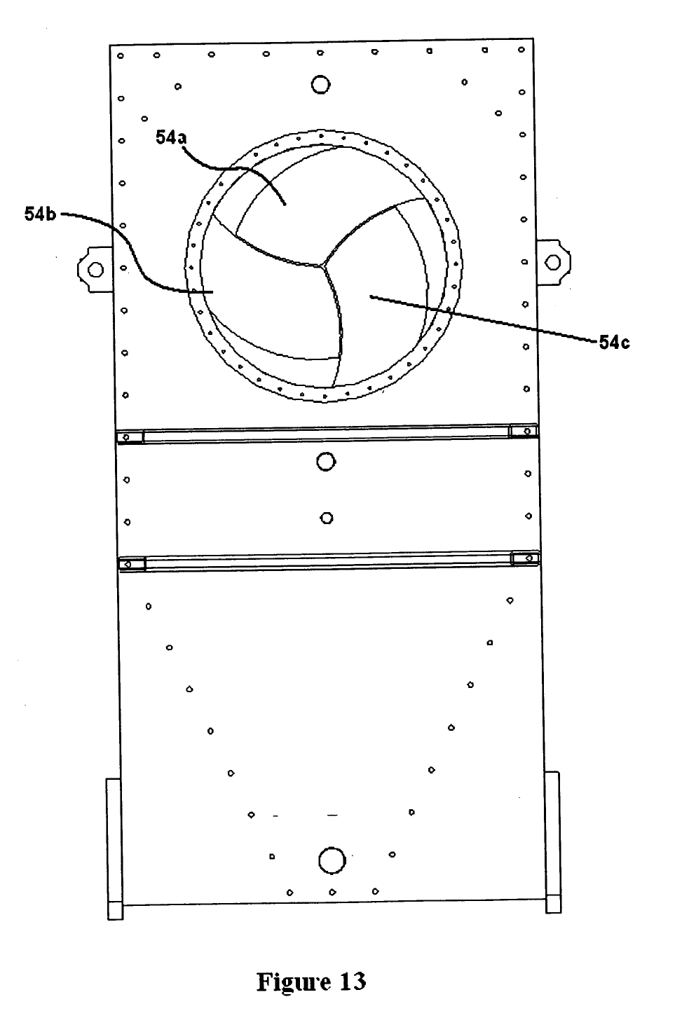

The present invention comprises an adjustable aperture 18, preferably comprising an iris mechanism, which enables variation of the iris size from all the way open (exposing the whole wafer) (FIG. 11), through partially masking substrate 50 (FIG. 12), to completely closed (FIG. 13). The iris mechanism is preferably computer controlled; the size of the iris may be adjusted, even while deposition is proceeding, to provide precise control of the deposition characteristics, including but not limited to the rate of deposition, the deposition thickness, and the variance in deposition thickness. Other variable aperture means may be utilized instead.

A preferred embodiment of the iris mechanism aperture 18 of the present invention comprises at least three paddles 54(a)-(c), preferably connected via posts protruding through the cell via an o-ring sealed port to belt 22 driven by stepper motor 20 that articulates the paddles in unison so that they close down to a desired aperture size, thereby reducing the open area of substrate 50 mounted on the cathode. Any type of motor or actuator may be used instead of stepper motor 20. Optionally, more paddles 54 may be used, making the opening in aperture 18 more circular.

The variable aperture also enhances the ability of the present invention to plate submicron structures, such as wafer interconnects. Because these structures give rise to highly nonuniform current densities, successful plating requires extremely precise plating parameter control. Along with pressurizing the cell, varying the aperture size provides this control so that the structures are uniformly plated regardless of the line width, pitch, or density of the pattern.

Also, different wafer designs require different optimal settings of the aperture size due to differences in the total metallization area and distribution and density of features to be plated. The variable size aperture allows the user to precisely optimize the system for each wafer design. And an adjustable aperture means that the user does not have to replace the aperture for each separate wafer design.

The present invention is also a dynamic profile anode 100 that may be used for plating, electroplating, electrodeposition, chemical and mechanical polishing (CMP), electropolishing, etching, electrolysis, or any other electrochemical process. Although shaped anodes are known in the art, the present invention is of an anode whose profile can be modified before or even during processing. Examples of profiles include but are not limited to flat, convex, domed, curved, hemispherical, conical, pyramidal, or any combination thereof. The shape used will be determined through experimentation and optimized for various types of wafer patterns. For example, conical-type shapes concentrate the ionic current toward the center of the substrate or cathode, thereby providing an additional method of maximizing the uniformity of the deposit thickness across the substrate.

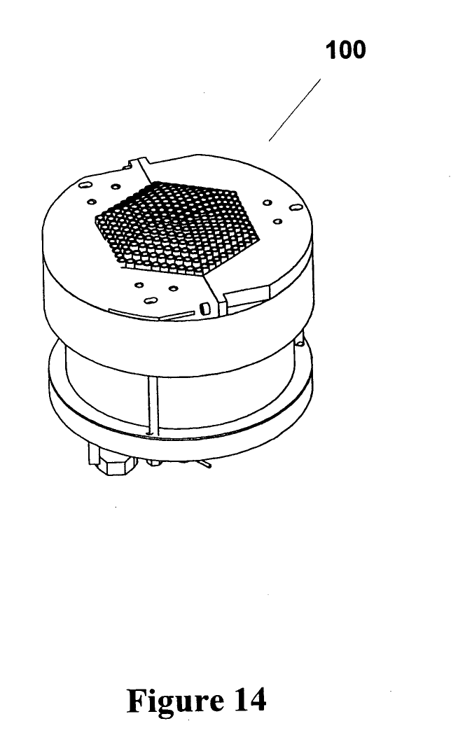

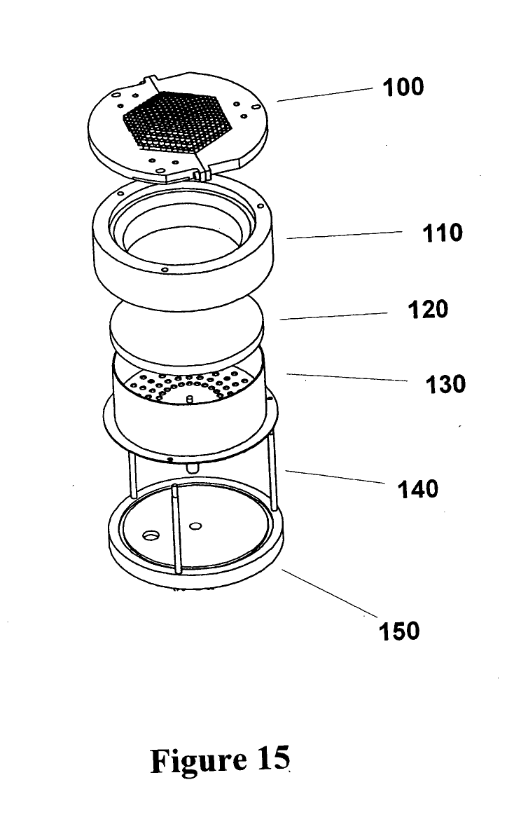

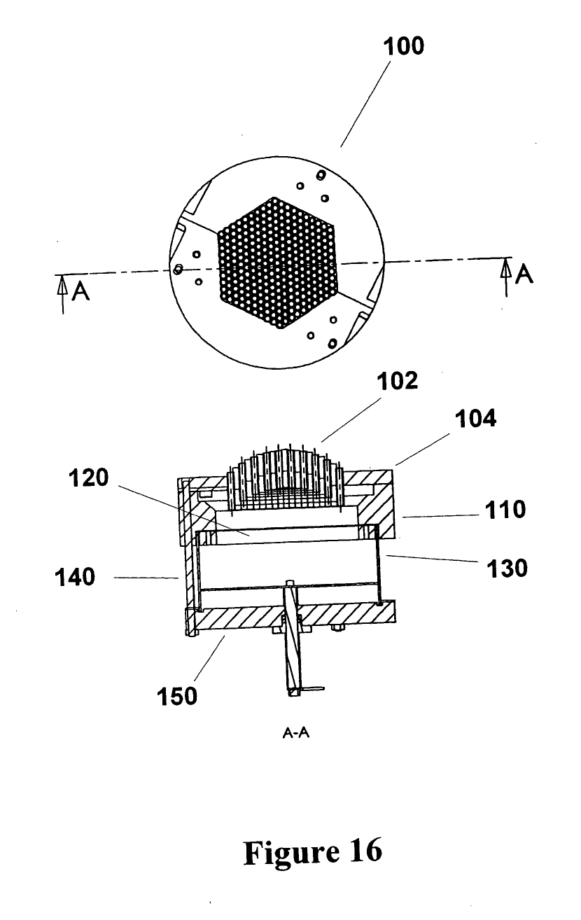

FIG. 14 shows one embodiment of the anode assembly, with an exploded view in FIG. 15 and a cross section in FIG. 16. The assembly comprises anode 100, which is seated in anode diaphragm 110. Filter 120, preferably cloth or polypropylene, allows ions to pass but prevents contamination from soluble metallic plating media in basket 130 from reaching anode 100 and eventually the cathode. Basket 130, which preferably comprises titanium or another non-soluble metal, is connected via contact rods 140 to base 150.

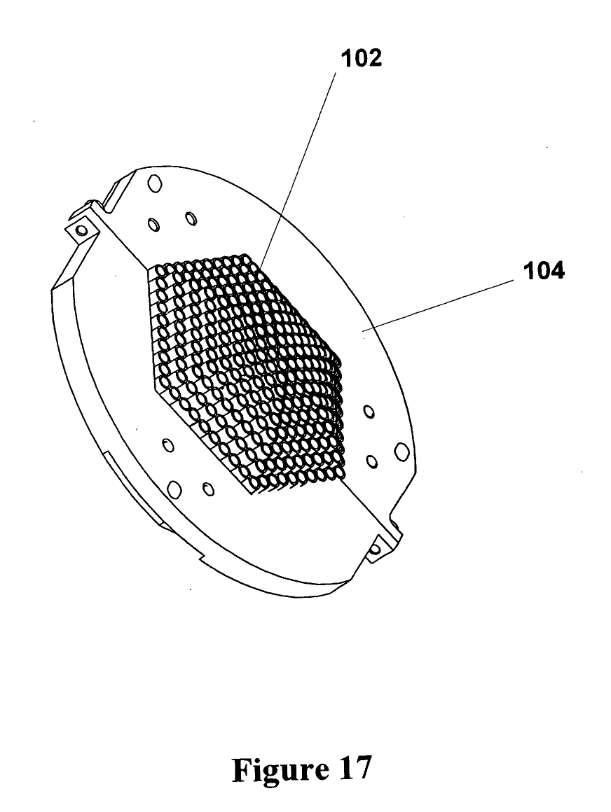

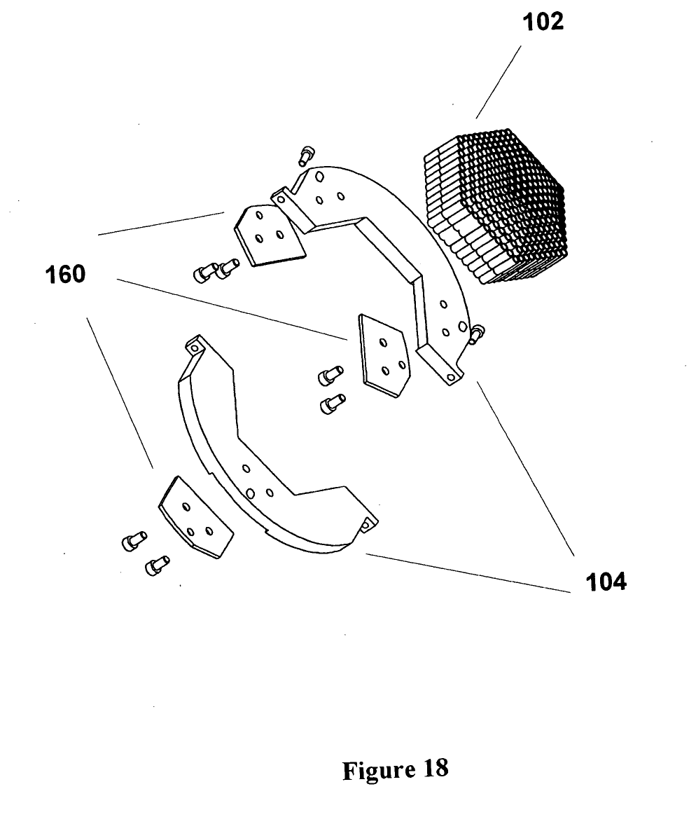

FIGS. 17 and 18 detail the construction of anode 100. Anode 100 is comprised of tubes 102 which form a stack up which provides the shape of the surface profile of anode 100, and clamp ring 104 which secures tubes 102 in place so it is dimensionally stable once the desired surface profile is achieved. Contact bus plates 160 conduct electrical current to anode 100. Tubes 102 are preferably cylindrical but may comprise any cross-sectional shape.

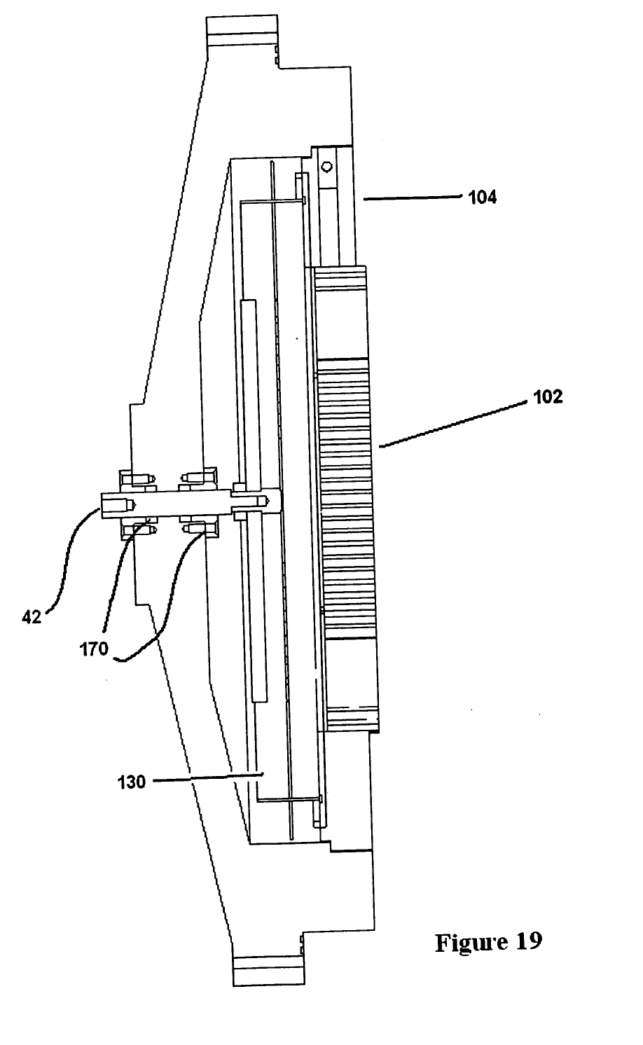

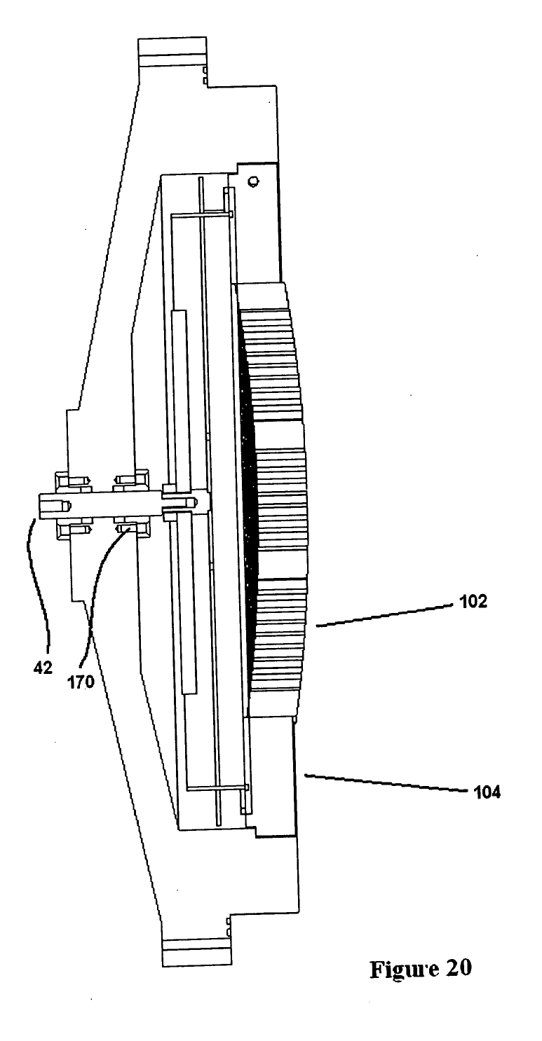

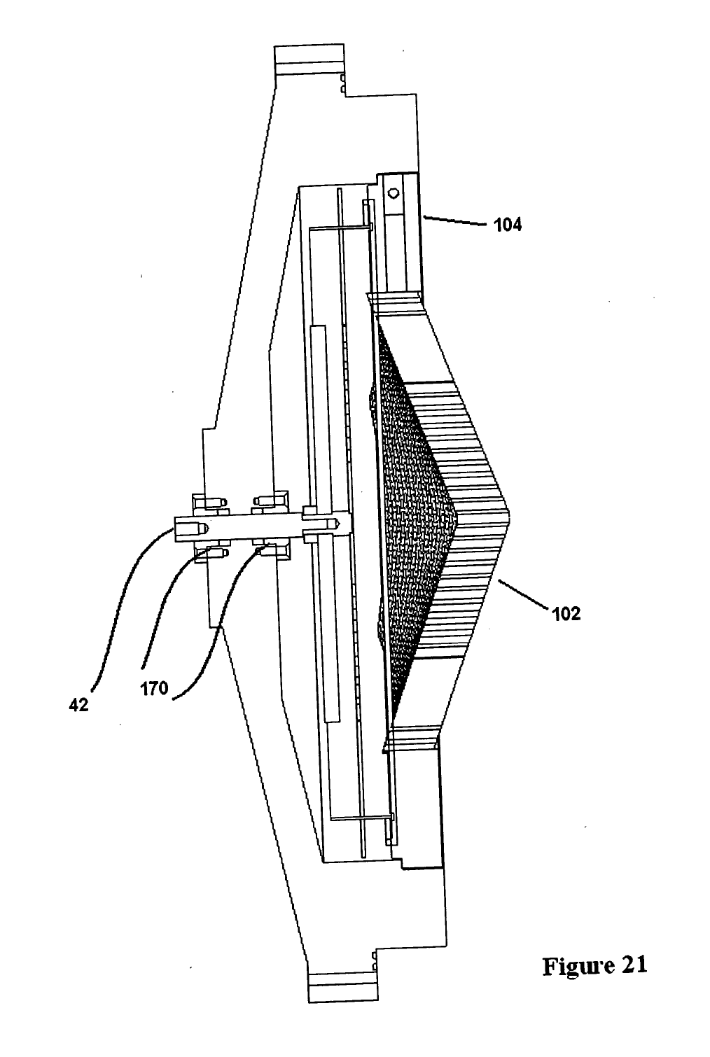

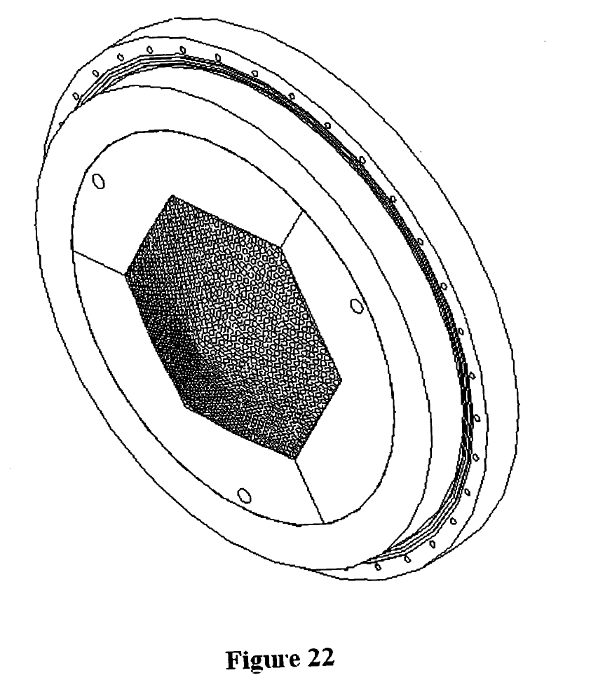

Another embodiment of dynamic profile anode 100 is shown in FIGS. 19-22. FIG. 19 is a cross section view showing a flat surface profile. Current is provided from positive terminal 42 through o-ring seals 170 to basket 130, clamp ring 104 and tubes 102. FIG. 20 depicts a convex surface profile, while FIGS. 21 and 22 show a cross section view and isometric view, respectively, of anode 100 with a conical surface profile. The surface profile may be changed by removing clamp ring 104, adjusting tubes 102 until the desired profile is achieved, and then engaging clamp ring 104 to hold tubes 102 in place.

Optionally, remotely controlled actuators may be used to change the surface profile of anode 100 in situ; that is, during processing. This has the advantage of permitting the optimization of the surface profile without having to open the deposition cell, reducing down time and eliminating any resulting contamination. The actuators may optionally comprise a portion of a feedback loop, thereby providing for automatic control of the deposition process by continually modifying the surface profile in reaction to monitored process parameters including but not limited to deposit thickness, deposit uniformity, electrolyte concentration, operating current, and operating voltage.

Anode 100 is preferably removable or serviceable, accommodating the use of either soluble or insoluble materials to deposit onto the surface of the wafer. Anode 100 may optionally comprise a soluble material which dissolves during processing. Preferably, anode 100 may be platinized, or be otherwise insoluble. Unlike the prior art, the use of hollow tubes 102 allows a metallic ion source, for example shot, chunks, rings, plates or bars of a desired anode metal or alloy, which is preferable to a metal salt solution, to be placed in basket 130 behind the anode. But because anode 100 is itself insoluble, it retains the exact desired shape throughout the deposition process. This combination permits anode 100 to be placed very close to substrate 50. Typical prior art systems require the distance between the anode and cathode to be at least 10 cm. While allowing for any distance, the anode design of the present invention permits anode 100 to be situated at a distance from substrate 50 of less than 5 cm, more preferably less than 1 cm, and most preferably less than 0.5 cm. The ability to utilize such a short distance greatly improves the control of the deposition, which enhances the uniformity of deposit across substrate 50. In addition, a shorter path for the ions to flow to the cathode means that contamination of substrate 50 with other ions in solution, or ions from a metallic component in the bath, is drastically reduced.

Anode 100 of the present invention thus provides for the use of soluble metallic anodic materials but does not change its surface profile due to the corrosion of the anodic material during deposition, unlike anodes known in the art. However, if desired, the user may controllably vary the surface profile of anode 100 in order to obtain a shape that optimizes the deposition process. This ability to modify the anode's shape as desired, while at the same time retaining the desired shape (i.e. preventing corrosion) during use of such soluble metallic materials, is novel.

In the present application the system preferably injects the electroplating solution directly into the anode basket 130 in order to help promote the convection of the electron flow carrying the ion matter from the anode into the cell's process area. In addition, it is preferable that the pressure at anode 100 is less than the pressure at substrate 50, or cathode, so no countercurrents develop which might disrupt laminar flow of the electrolyte adjacent to the substrate 50.

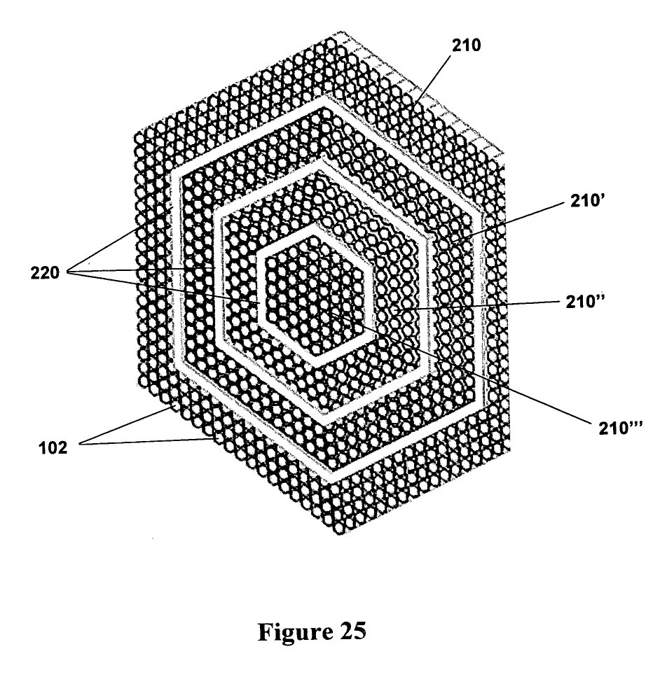

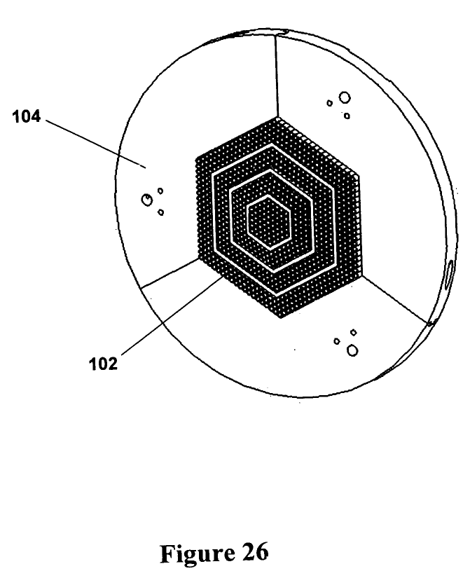

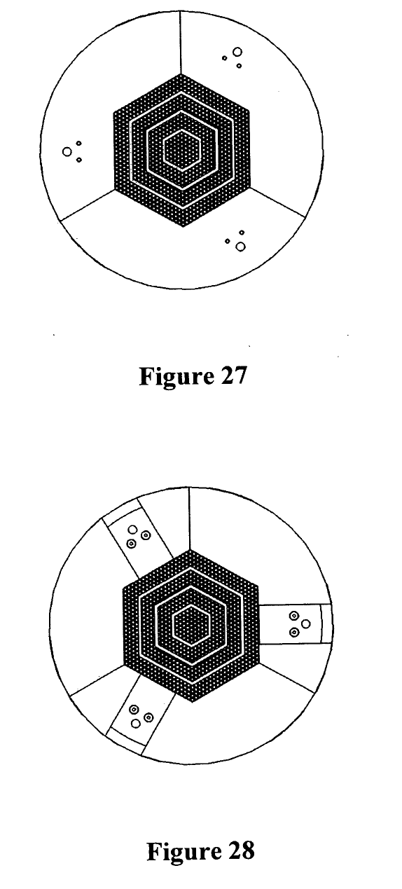

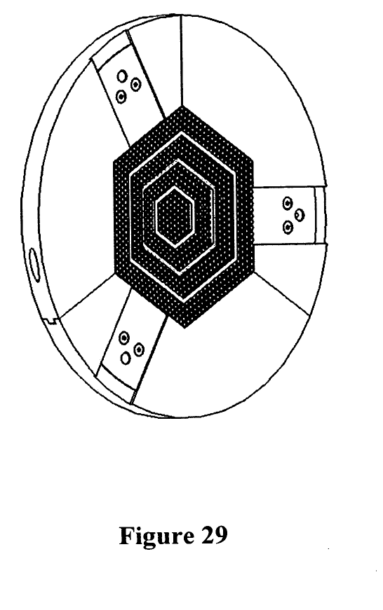

Tubes 102 may optionally be configured in multiple concentric regions or zones 210, 210′, 210″, 210″′. A preferred embodiment of this concentric zone anode is shown in the various views depicted in FIGS. 25-29. Although four such zones are depicted in the figures, any number may be employed. Although the zones are depicted in the figures as being hexagonal in shape, the zones may be configured to comprise any shape, including but not limited to circular or polygonal shapes. Optionally the zones are not concentric, but can take any shape or size and be situated anywhere on the anode. The zones are separated by separators 220, which are preferably electrically insulating. Each zone is preferably selectively, individually and/or differentially electrically addressable. This is preferably accomplished by electrically connecting individual anode elements which are located at a common fixed distance from the anode center, i.e. which are in the same zone, so that they are all operating at a common controlled voltage and electrical current. Multiple concentric electrically variable anode regions can be created as desired by use of a multi-channel electrical plating rectifier. Each variable anode region would then preferably be connected to a different rectifier channel. The wafer or substrate metallization surface to be electroplated would preferably serve as a common cathode for all rectifier channels. In this configuration, the anode can be operated in one of two general modes. In a first mode, with all rectifier channels set to a common voltage/current setting, the anode functions in the conventional sense; e.g. as a single unitary anode electrode. In a second mode, each zone may be set to a different voltage/current setting.

In the field of microelectronic substrate and semiconductor wafer metals plating, it is well known to practitioners of the art that variations in the electrical field, voltage and current density relationship between the anode and the substrate surface to be plated cause variations in both the thickness and microstructure of the plating deposit. By operating the anode in the second mode, the multi-region variable anode configuration facilitates an adjustment to the nature and strength of the electrical field conditions to different regions of the anode surface corresponding to different regions of the substrate being plated. Adjusting and varying the electrical properties of each concentric anode region in this manner before and during the plating process facilitates a marked improvement in the flatness, homogeneity and microstructure of the plating deposit.

In addition to the being operated as a single cell or a dedicated cell for a specific chemical operation, the present invention may be used as a multiple process cell. A first plating solution is introduced into the cell and a first operation is performed. The first plating solution may then be rapidly drained, and a rinsing chemistry is preferably circulated throughout the cell. The rinsing step may be repeated for a number of cycles to achieve a desired level of purity of the rinsed wafer surface. Subsequent chemical processes may then be performed to deposit additional electroplated films or multiple compositions. For example, a substrate may be plated with a nickel film over a copper film and followed by a tin film. Or ceramic panels used in thick film type packaging, which require multiple layer film formation, can be produced. Because the system is preferably closed and filtered, clean room conditions with little contamination can be maintained throughout the entire multiple operation process. This feature is also facilitated by the adjustable aperture and dynamic profile anode, which allows the user to choose the optimal iris size (or sizes) and anode profile for a particular process without having to open the cell and replace the aperture.

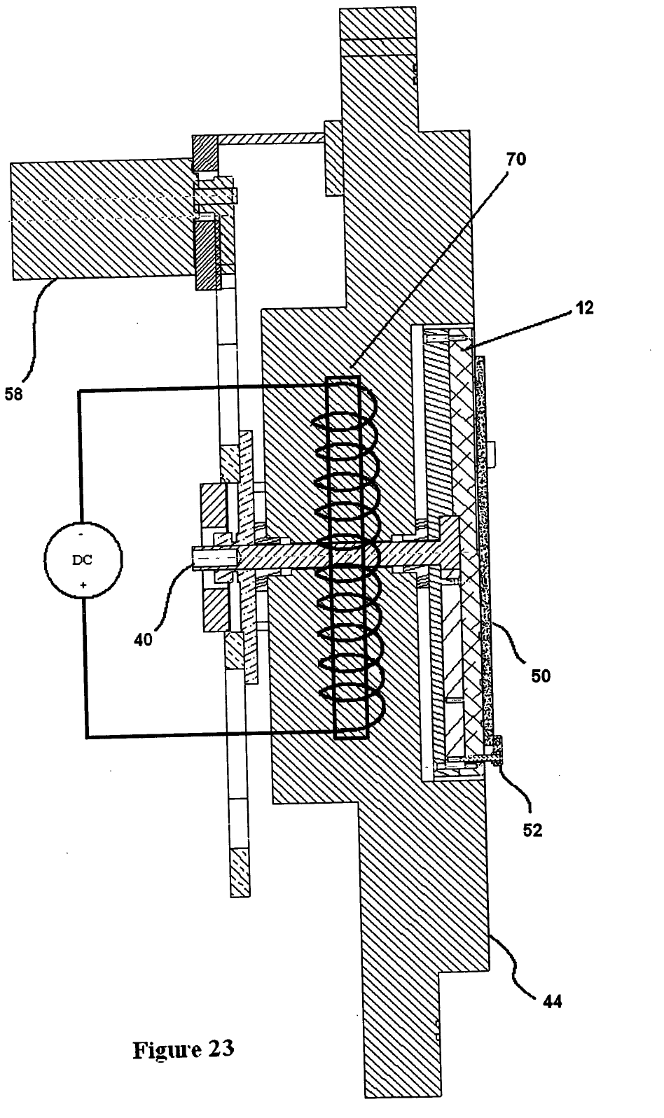

Optionally the chuck may be magnetic, which allows for magnetic particle codeposition. This process is more fully described in U.S. Provisional patent application Ser. No. 60/519,813, entitled “Particle Coelectrodeposition”, and U.S. patent application Ser. No. 10/728,636, entitled “Coated and Magnetic Particles and Applications Thereof”. One example of such a chuck is the back seal electrolytic vacuum chuck, disclosed in U.S. Provisional Patent Application Attorney Docket No. 31248-5, entitled “Pressurized Autocatalytic Vessel and Vacuum Chuck”, filed on Feb. 4, 2004. The specifications and claims of these references are incorporated herein by reference. One embodiment of such a chuck is shown in FIG. 23, which is identical to FIG. 8 except that it includes electromagnet 70. The magnetic field may be provided by an electromagnet as depicted, or alternatively a permanent magnet, an array of magnets, or the like. The presence of the magnetic field allows magnetic particles to be codeposited on substrate 50 in a highly controlled manner before, during, or after the deposition of the electrolytic plating, providing numerous chemical, material, and mechanical advantages to the deposited structures.

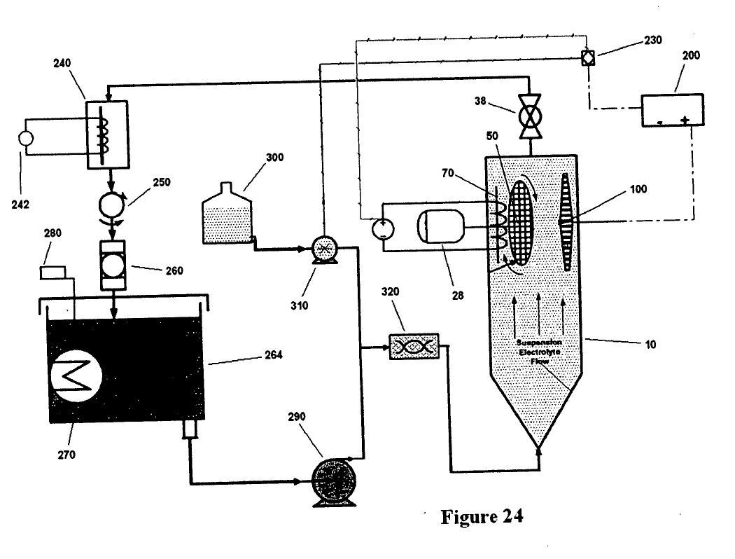

FIG. 24 depicts a schematic and flow diagram of a preferred embodiment of a co-deposition tool and process. Pump 290 pumps electrolyte stored in tank 264 to mixer 320, where it is mixed with a slurry of magnetic particles in suspension which was pumped from slurry tank 300 by slurry pump 310. The suspension-electrolyte mixture enters cell 10 and proceeds upward in laminar flow to the codeposition area comprising anode 100 and substrate 50. Substrate 50 preferably rotates via motor 58. Electromagnet 70 attracts magnetic particles from the suspension-electrolyte so that they are codeposited on substrate 50 along with the electrochemical deposition. Controller 230 controls deposition parameters, such as the electrode voltage via DC power supply 200 and the concentration of magnetic particles in the suspension-electrolyte mixture via slurry pump 310.

Waste suspension-electrolyte mixture exits cell 10 through pressure valve 38. Magnetic separator 240 strips out excess particles from the suspension-electrolyte mixture via an adjustable magnetic field provided by DC separator power supply 242. Nonmagnetic particles and sediments are filtered out using rotary filter 250 and cartridge filter 260, although other types of filters may be used. The filtered electrolyte is then recirculated back into tank 264, where it is cooled via heat exchanger 270 controlled by temperature control 280. The electrolyte may thus be recycled, providing substantial cost savings.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. An anode for use in an electrochemical process, the anode comprising:
a plurality of parallel electrically conducting elements arranged in a plurality of zones; and
one or more separators for separating said zones.

2. The anode of claim 1 wherein said plurality of zones are concentric.

3. The anode of claim 2 wherein each zone comprises a shape selected from the group consisting of circle, polygon, and regular polygon.

4. The anode of claim 1 wherein a surface profile of said anode is variable during operation of the electrochemical process.

5. The anode of claim 1 wherein said separators are electrically insulating.

6. The anode of claim 5 wherein an electrical characteristic of each of said zones is independently settable.

7. The anode of claim 6 wherein said electrical characteristic is selected from the group consisting of voltage and current.

8. The anode of claim 5 further comprising a multi-channel rectifier.

9. The anode of claim 1 wherein said zones comprise the same voltage and current setting.

10. A method of electrolytically depositing a material on a substrate, the method comprising the steps of:
providing an electrolytic cell;
providing an anode comprising a plurality of parallel electrically conducting elements arranged in a plurality of separated zones; and
independently setting a value of an electrical characteristic for each of the zones.

11. The method of claim 10 wherein the electrical characteristic is selected from the group consisting of voltage and current.

12. The method of claim 10 wherein the setting step is performed while the material is being deposited on the substrate.

13. The method of claim 10 wherein the setting step is performed before the material is deposited on the substrate.

14. The method of claim 10 wherein the plurality of separated zones are concentric.

15. The method of claim 12 further comprising the step of monitoring a deposit characteristic selected from the group consisting of flatness, homogeneity, and microstructure.

16. The method of claim 15 wherein the setting step is performed in order to improve the characteristic.

17. The method of claim 10 further comprising the step of varying a surface profile of the anode.

18. The method of claim 17 wherein the varying step is performed while the material is being deposited on the substrate.

19. The method of claim 18 further comprising the step of measuring a value of a parameter selected from the group consisting of deposit thickness, deposit uniformity, electrolyte concentration, operating current, and operating voltage.

20. The method of claim 19 where the varying step is performed in response to the measured parameter value.
